(19) United States
(12) Patent Application Publication
(10) Pub. No.: US 2008/0236622 A1
(43) Pub. Date: Oct. 2, 2008

(54) Control method of dish washing machine

(75) Inventors: Seong Ho Kim, Seoul (KR); Tae Hee Lee, Seoul (KR)

Correspondence Address: MCKENNA LONG & ALDRIDGE LLP, 1900 K STREET, NW, WASHINGTON, DC, 20006, US

(73) Assignee: LG. Electronics, Inc., Seoul (KR)

(21) Appl. No.: 11/878,930

(22) Filed: Jul. 27, 2007

(30) Foreign Application Priority Data
Mar. 31, 2007 (KR) 10-2007-0032121

(51) Int. Cl. B08B 3/04; B08B 7/04

(52) U.S. Cl. 134/18; 134/56 D

(57) ABSTRACT

A method for controlling a home appliance is disclosed. The method includes selecting one of a plurality of steam washing modes for washing dishes. Each steam washing mode has a corresponding steam washing pattern. Selecting the number of steam washing pattern cycles for the selected steam washing mode, or selecting the operation time associated with the steam washing pattern that corresponds to the selected steam washing mode.

### CROSS-REFERENCE TO RELATED APPLICATION

This application claims the benefit of Korean Patent Application No. 10-2007-0032121, filed on Mar. 31, 2007, which is hereby incorporated by reference in its entirety as if fully set forth herein.

### BACKGROUND

1. Field of the Disclosure

The present disclosure relates to a control method of a home appliance, and more particularly, to a control method of a dish washing machine that is capable of more efficiently washing dishes.

2. Discussion of the Related Art

Generally, dish washing machines are known as an apparatus for automatically washing dishes disposed in a washing compartment by spraying water toward the dishes under high pressure, and thus, removing foreign matter such as food residues attached to the surfaces of the dishes.

One of the important factors associated with such a dish washing machine is washability which relates to cleanly removing food residues attached to the surfaces of dishes. In order to enhance washability, it is necessary to increase the force required to remove foreign matter from the surfaces of dishes, namely, the spray pressure of water. However, when the spray pressure of the water is excessively high, the dishes may be damaged or easily broken. Furthermore, when dish washing is carried out at an increased spray pressure, the amount of water required in this washing operation is increased.

Also, when an increased spray pressure is used to supply water, it is necessary to increase the power consumption of a pump used to supply the water.

In addition, water is simply supplied to the dishes, which is a washing operation of the dish washing machine, and therefore, the washing time is increased.

### SUMMARY

Accordingly, the present invention is directed to a control method of a dish washing machine that substantially obviates one or more problems due to limitations and disadvantages of the related art.

A control method of a dish washing machine that is capable of improving the washing efficiency while reducing water consumption is highly desirable.

Another object of the present invention is to provide a control method of a dish washing machine that is capable of reducing the washing time through the various performances of a washing operation.

Advantages and features will be set forth in part in the description which follows and in part will become apparent to those having ordinary skill in the art upon examination of the following or may be learned from practice of the invention. The aforementioned advantages and features may be realized and attained by the exemplary structure and/or method pointed out in the written description, claims and the appended drawings.

The advantages may be achieved by a control method of a dish washing machine that may include selecting one of a plurality of steam washing modes, where each of the steam washing modes has a corresponding steam washing pattern; and selecting a number of steam washing pattern cycles for the selected steam washing mode.

The advantages may also be achieved by a control method of a dish washing machine that may include selecting one of a plurality of steam washing modes, where each of the steam washing modes has a corresponding steam washing pattern; and selecting an operating time associated with the steam washing pattern that corresponds to the selected steam washing mode.

The advantages may be further achieved by a dish washing machine that may include means for selecting one of a plurality of steam washing modes, where each of the steam washing modes has a corresponding steam washing pattern; and at least one of means for selecting a number of steam washing pattern cycles for the selected steam washing mode and means for selecting an operating time associated with the steam washing pattern that corresponds to the selected steam washing mode.

It is to be understood that both the foregoing general description and the following detailed description are exemplary and explanatory and shall not be construed as limiting the scope of the claims.

### BRIEF DESCRIPTION OF THE DRAWINGS

The accompanying drawings, which are included to provide a further understanding of the invention and are incorporated in and constitute a part of this specification, illustrate embodiment(s) of the invention and together with the description serve to explain the principle of the invention.

In the drawings:

FIG. 1 is a sectional view schematically illustrating an embodiment of a dish washing machine according to the present invention;

FIG. 2 is a flow chart illustrating an embodiment of a control method for operating the dish washing machine of FIG. 1;

FIG. 3 is a flow chart illustrating the step of selecting the steam washing mode of FIG. 2;

FIG. 4 is a flow chart illustrating the step of selecting the number of execution times of the steam washing pattern of FIG. 2;

FIG. 5 is a flow chart illustrating the step of selecting the operation time of the steam washing pattern of FIG. 2;

FIG. 6 is a table illustrating a first embodiment of a steam washing mode of the dish washing machine shown in FIG. 1;

FIG. 7 is a table illustrating a second embodiment of a steam washing mode of the dish washing machine shown in FIG. 1;

FIG. 8 is a table illustrating a third embodiment of a steam washing mode of the dish washing machine shown in FIG. 1;

FIG. 9 is a table illustrating a fourth embodiment of a steam washing mode of the dish washing machine shown in FIG. 1;

FIG. 10 is a table illustrating a fifth embodiment of a steam washing mode of the dish washing machine shown in FIG. 1; and

FIGS. 11A to 11D are graphs illustrating the operation of the dish washing machine according to steam washing patterns.

### DETAILED DESCRIPTION

Reference will now be made in detail to the preferred embodiments of the present invention, examples of which are illustrated in the accompanying drawings. Wherever possible, the same reference numbers will be used throughout the drawings to refer to the same or like parts.

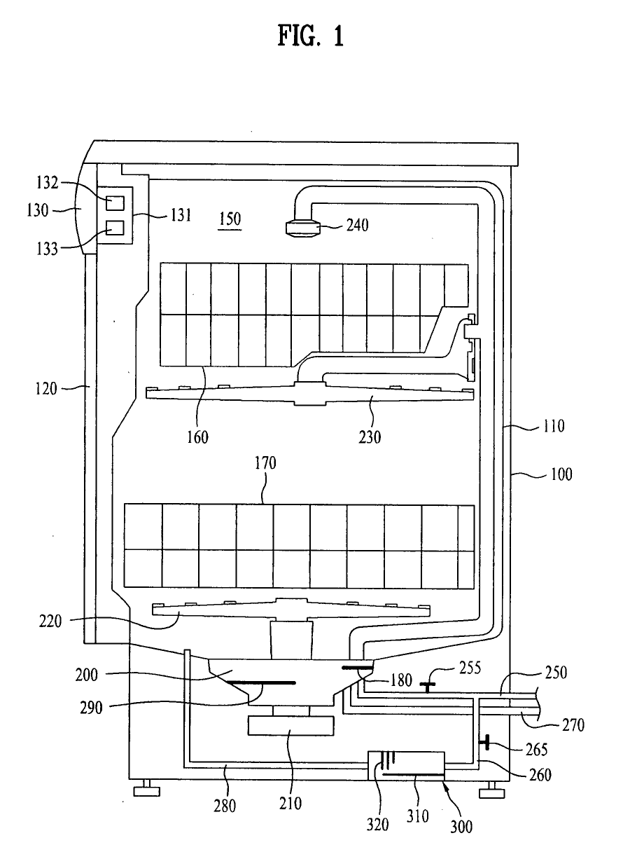

The configuration of a dish washing machine according to an exemplary embodiment of the present invention will be described with reference to FIG. 1.

The illustrated dish washing machine may include a case 100 defining the appearance of the dish washing machine, a door 120 for opening or closing the case 100, and a control panel 130 mounted to the case 100 or door 120, to enable the user to manipulate the dish washing machine.

A tub 110 is arranged in the case 100, to define a washing compartment 150 in the case 100, as a space in which dishes are received and washed. A sump 200 for storing water is arranged beneath the tub 110.

Arranged in the sump 200 are a pump 210 for pumping the water stored in the sump 200 and a filter (not shown) for filtering contaminated water. A first heater 290 is also arranged in the sump 200, to heat the water stored in the sump 200.

A first water supply tube 250 is connected to the sump 200, to supply fresh water from an external water supply source to the sump 200. A water discharge tube 270 is also connected to the sump 200, to externally discharge the water from the sump 200. A first water supply valve 255 for controlling the supply of water to the sump 200 is arranged in the water supply tube 250.

At least one rack 160 is arranged in the interior of the tub 110, namely, the washing compartment 150. At least one spray arm 230 is also arranged in the washing compartment 150, to spray the water pumped by the pump 210 toward the at least one rack.

For reference, FIG. 1 illustrates an example in which an upper rack 160 and a lower rack 170 are arranged at upper and lower portions of the washing compartment 150, respectively, and an upper spray arm 230 and a lower spray arm 220 are arranged such that they spray water pumped by the pump 210 toward the upper rack 160 and lower rack 170, respectively.

In addition, a top nozzle 240 may be arranged at a top portion of the washing compartment 150. The top nozzle 240 functions to downwardly spray water pumped by the pump 210 from the top portion of the washing compartment 150.

The dish washing machine according to the illustrated embodiment of the present invention is configured not only to spray water into the washing compartment 150 by the pump 210 and spray arms 220 and 230, but also to spray or supply steam to the washing compartment 150. To this ends the dish washing machine includes a steam generator 300 which operates independently of the first heater 290 arranged in the sump 200.

As shown in FIG. 1, the steam generator 300 communicates with the first water supply tube 250 via a second water supply tube 260. The steam generator 300 also communicates with the washing compartment 150 of the tub 110 via a steam supply tube 280. A second water supply valve 265 for controlling the supply of water to the steam generator 300 is arranged in the second water supply tube 260.

The steam generator 300 includes a second heater 310 for heating water supplied to the steam generator 300, and a water level sensor 320 for sensing the water level of the steam generator 300. The water level sensor 320 may sense, for example, a minimum water level and a maximum water level.

The minimum water level is set to protect the second heater 310 of the steam generator 300. On the other hand, the maximum water level is set to prevent the water supplied to the steam generator 300 from overflowing the steam generator 300.

Also, the steam generator may be provided with a steam supply valve (not shown) for controlling the opening and closing of the steam supply tube 280 to supply steam at desired time.

In addition, the dish washing machine may further include a contamination sensor 180 for measuring the contamination level of water being used to wash the dishes. The contamination sensor 180 is mounted at one side of the sump for measuring the contamination level of water circulating in the tub.

The dish washing machine includes a control unit 131 for selecting a steam washing mode of the dish washing machine on the basis of the load detected by the contamination sensor 180 or the user's input. The control unit 131 includes a controller 132 and memory 133.

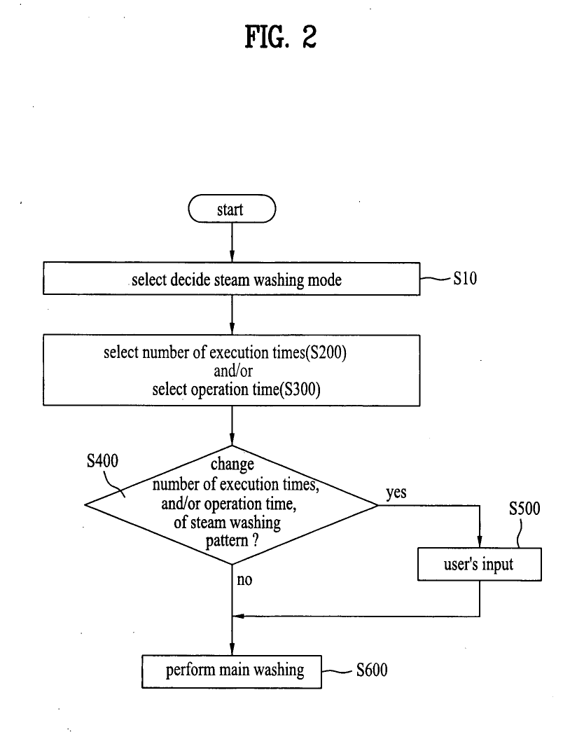

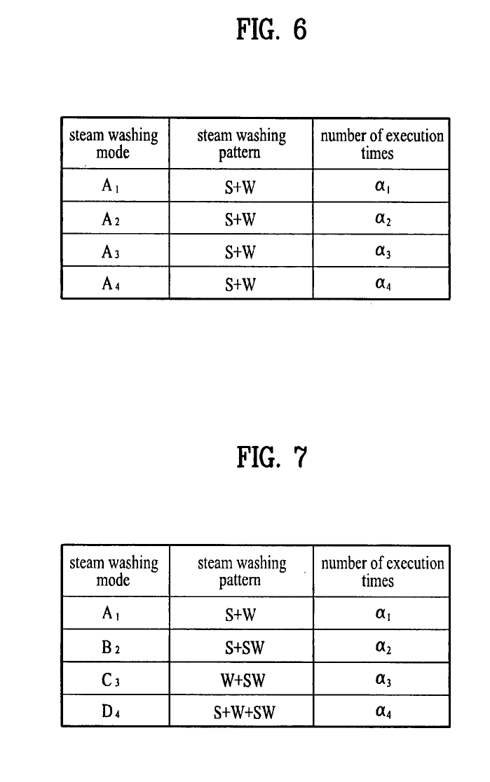

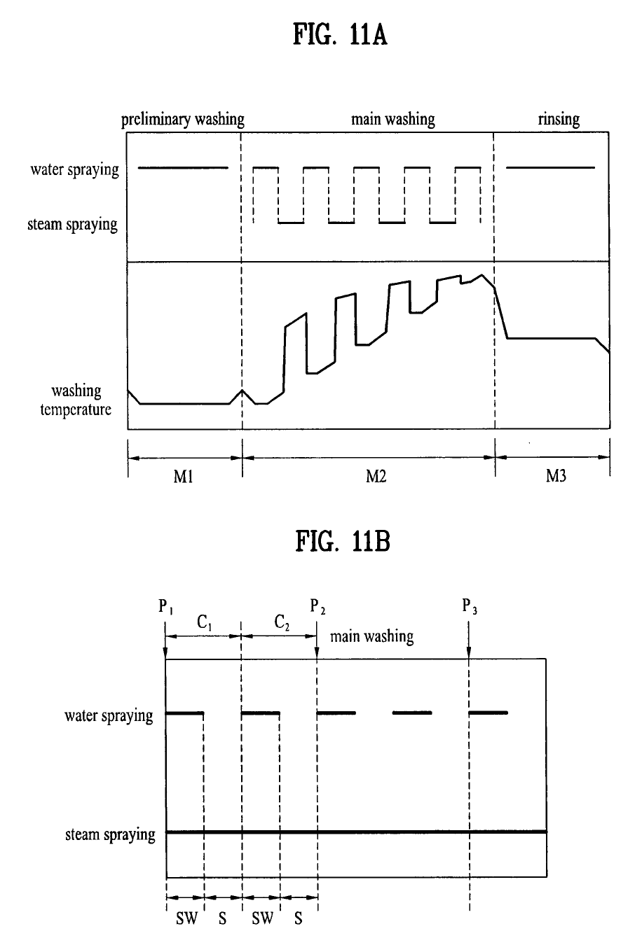

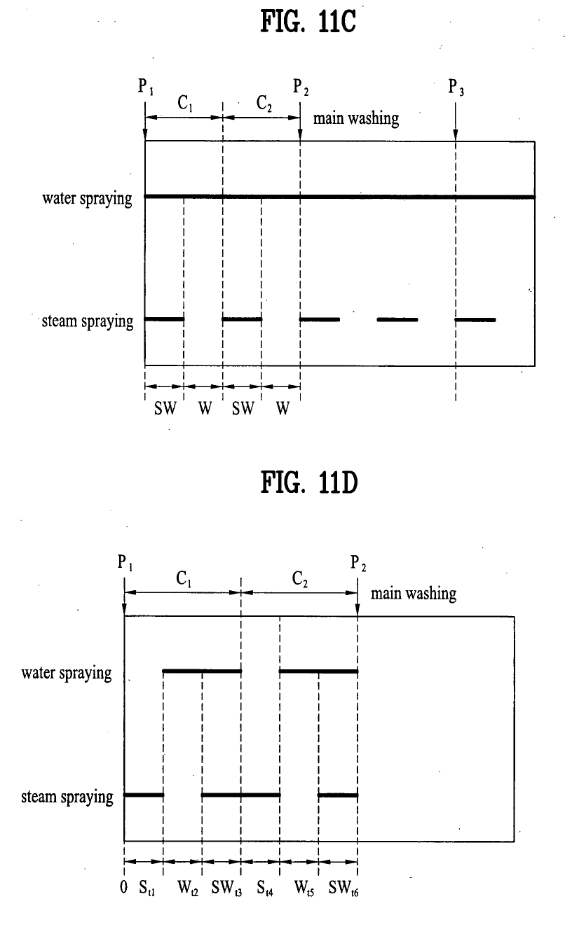

The method for controlling the dishwasher as illustrated in FIGS. 2-5, as well as the tables in FIGS. 6-10 and the timing diagrams of FIGS. 11a-11d may be implemented through a series of instructions stored in the memory 133 associated with the control unit 131.

The control unit 131 is electrically connected to electrically-operating elements, for example, the control panel 130, the pump 210, and the steam generator 300, to control the operation of the dish washing machine.

For example, the control unit 131 controls the first heater 290, the second heater 310, the pump 210, and the steam generator 300 according to the operation mode of the dish washing machine. A process for controlling the above-specified parts of the dish washing machine according to the steam washing mode of the dish washing machine will be described below.

Hereinafter, a control method of the dish washing machine according to the present invention will be described with reference to FIGS. 2 through 11D.

The possible operations that can be performed by the dish washing machine according to the present invention include a preliminary washing operation M1, a main washing operation M2, and a rinsing operation M3.

The preliminary washing operation M1 is a process for preliminarily washing dishes. The main washing operation M2 is a process for washing the dishes using water containing detergent. The rinsing operation M3 is a process for spraying water toward the dishes, washed through the main washing operation M2, to rinse the dishes.

The preliminary washing operation M1, the main washing operation M2, and the rinsing operation M3 are sequentially carried out. First of all, the preliminary washing operation M1 is carried out (S10).

In the preliminary washing operation, water, supplied into the sump 200 from the outside, is supplied to dishes without heating the water. That is, low-temperature water is supplied to the dishes. The preliminary washing operation is carried out to roughly remove foreign matter from the dishes.

Additionally, heated water may be supplied to the dishes in the preliminary washing operation. In addition, the water may or may not contain detergent in the preliminary washing operation.

After the completion of the preliminary washing operation, the main washing operation is carried out. In the main washing operation, the dishes are washed according to a steam washing mode predetermined before the main washing operation.

In the steam washing mode, the control unit 131 controls a steam washing pattern, including at least two of a water spraying process W for supplying water to the dishes, a steam spraying process S for supplying steam to the dishes, and a water/steam spraying process SW for simultaneously supplying water and steam to the dishes, to be repeatedly performed in succession.

After the completion of the main washing operation, the circulated water is discharged to the outside through the water discharge tube 270. Subsequently, a rinsing operation, in which new water is supplied to the dishes, is carried out. In the rising operation, only water is supplied to the dishes. At this time, heated or unheated water may be supplied to the dishes.

Although the unheated water is supplied to the dishes, the washing temperature is maintained higher than that of the preliminary washing operation. This is because the temperature of the dishes or the interior temperature of the washing compartment is already raised to a specific temperature through the main washing operation.

Additionally, the water and steam may be simultaneously or alternately supplied to the dishes in the rinsing operation. In addition, after the completion of the rinsing operation, a drying operation, in which cool air or hot air is supplied to the dishes to dry the dishes, may be carried out.

The steam washing mode may be selected by a user's selection thereof or on the basis of load detected by the contamination sensor, which will be described below in detail.

Upon the selection of the steam washing mode, a steam washing pattern is automatically generated according to the selected steam washing mode. Also, the steam washing pattern may be selected on the basis of load detected by the contamination sensor.

Upon the selection of the steam washing mode, the number of execution times of the steam washing pattern may be automatically generated. Alternatively, the number of execution times of the steam washing pattern (i.e., the number of steam washing pattern cycles) may be manually selected according to a user's input thereof.

Upon the selection of the steam washing mode, the operation time of the steam washing pattern may be automatically generated. Alternatively, the operation time of the steam washing pattern may be selected according to a user's input thereof.

After the number of execution times of the steam washing pattern and the operation time of the steam washing pattern are selected, they may be changed according to a command inputted by a user.

Consequently, the control method of the dish washing machine according to the present invention includes a step of selecting a steam washing mode (S10), a step of selecting the number of execution times of a steam washing pattern (S200), and a step of selecting the operation time of a steam washing pattern (S300).

After the completion of the above-described processes, the control unit 131 of the dish washing machine controls the main washing operation to be carried out.

In addition, the control method of the dish washing machine according to the present invention may further include a step of changing the number of execution times of the steam washing pattern and/or the operation time of the steam washing pattern (S400).

In the changing step, a user may input the changed number of execution times of the steam washing pattern and/or the changed operation time of the steam washing pattern (S500).

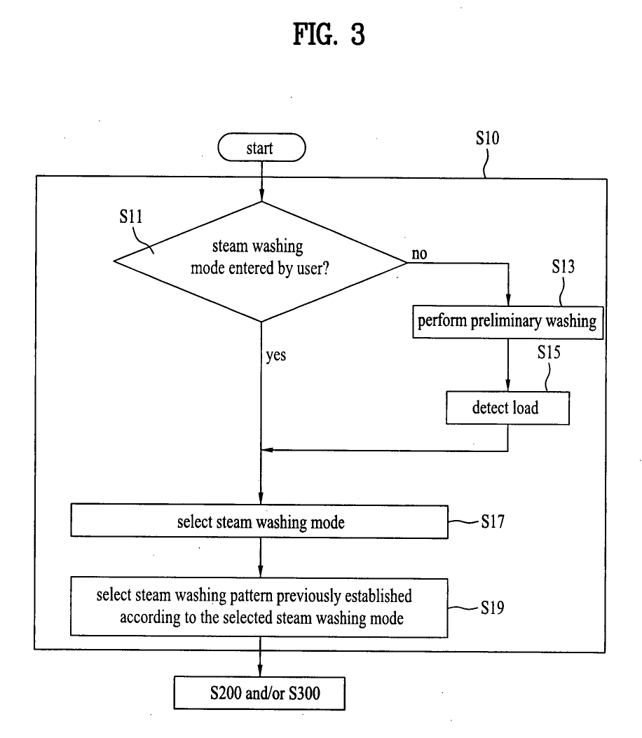

Hereinafter, the step of selecting the steam washing mode, in the control method of the dish washing machine according to the present invention, will be described in detail with reference to FIG. 3.

First, the user turns on a power switch of the dish washing machine to wash contaminated dishes, and then presses a start button disposed on the control panel.

Subsequently, the control unit 131 of the dish washing machine determines whether the user has selected a steam washing mode (S11).

When it is determined that the user has selected a steam washing mode, the control unit 131 recognizes the steam washing mode, selected by the user, as an operation steam washing mode (S17).

When it is determined that the user has not selected a steam washing mode, the control unit 131 controls the preliminary washing to be performed, and selects a steam washing mode on the basis of load detected by the contamination sensor (S13, S15, and S17).

Upon the selection of a steam washing mode, a steam washing pattern is automatically generated according to the selected steam washing mode (S19). That is, the steam washing pattern is previously established according to the steam washing mode in the control unit 131 of the dish washing machine.

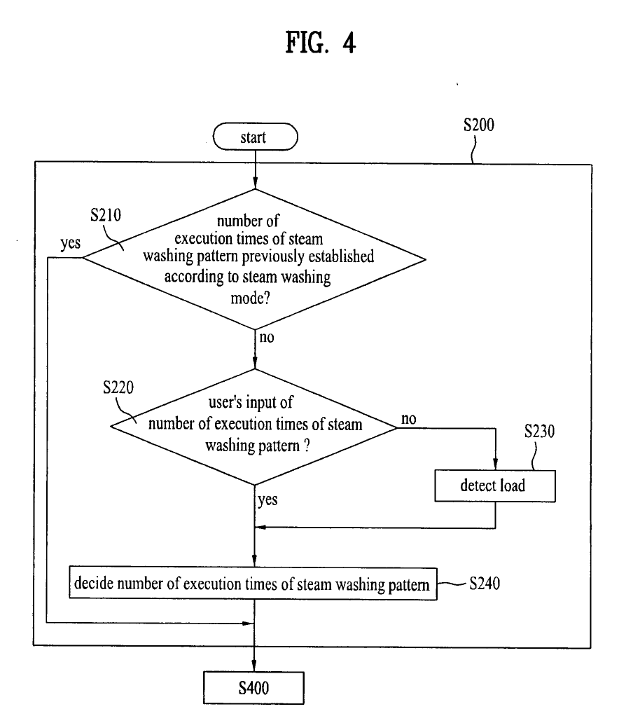

Hereinafter, the step of selecting the number of execution times of the steam washing pattern will be described in detail with reference to FIG. 4.

First, the control unit 131 determines whether the number of execution times of the steam washing pattern is previously established according to the steam washing mode selected at the previous step (S210).

When it is determined that the number of execution times of the steam washing pattern is previously established according to the steam washing mode, the control unit 131 recognizes the established number of execution times of the steam washing pattern as the target number of execution times of the steam washing pattern.

When the control unit 131 determines that the number of execution times of the steam washing pattern has not been established, the control unit 131 checks for user input of the number of execution times of the steam washing pattern (S220).

After the user has entered the number of execution times of the steam washing pattern, the control unit 131 recognizes the number of execution times of the steam washing pattern, entered by the user, as the target number of execution times of the steam washing pattern (S240).

On the other hand, when it is determined that the user has not entered the number of execution times of the steam washing pattern, the control unit 131 generates the number of execution times of the steam washing pattern on the basis of load detected by the contamination sensor (S230 and S240).

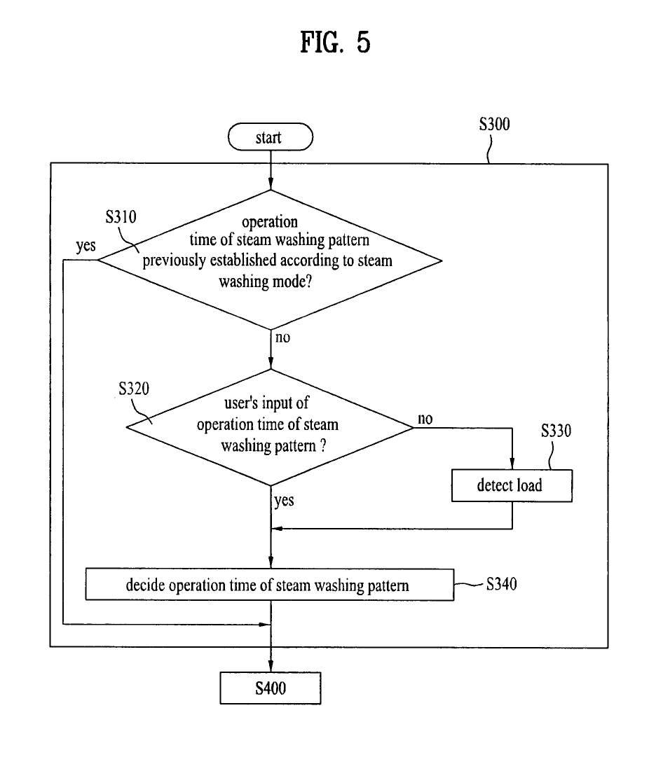

Hereinafter, the step of selecting the operation time of the steam washing pattern will be described in detail with reference to FIG. 5.

First, the control unit 131 determines whether the operation time of the steam washing pattern is previously established according to the previously selected steam washing mode (S310).

Here, the operation time of the steam washing pattern may be a particular operation time established individually for the water spraying process W, the steam spraying process S, and the water/steam spraying process SW, constituting the steam washing pattern when the steam washing pattern is performed once. Alternatively, the operation time of the steam washing pattern may be the pattern operation time including the sum of the particular operation times of the respective processes constituting the steam washing pattern. Also, the operation time may be the total operation time of the steam washing pattern during which the steam washing pattern is repeatedly performed.

When it is determined that the operation time of the steam washing pattern is previously established according to the steam washing mode, the control unit 131 recognizes the established operation time as the target operation time.

When it is determined that the operation time of the steam washing pattern is not established, the control unit 131 checks for user input of the operation time of the steam washing pattern (S320).

After the user has entered the operation time of the steam washing pattern, the control unit 131 recognizes the operation time of the steam washing pattern, entered by the user, as the target operation time of the steam washing pattern (S340).

On the other hand, when it is determined that the user has not entered the operation time of the steam washing pattern, the control unit 131 selects the operation time of the steam washing pattern on the basis of load detected by the contamination sensor (S330 and S340).

Hereinafter, a first embodiment of the steam washing modes of the dish washing machine according to the present invention will be described in detail with reference to FIG. 6.

In this embodiment, the steam washing pattern may be previously established such that the steam washing pattern is not changed with respect to different steam washing modes. In this embodiment, a criterion for distinguishing between the steam washing modes is the number of execution times of the steam washing pattern.

For example, as shown in FIG. 6, different steam washing modes A1, A2, A3, and A4 have the same steam washing pattern, i.e., the steam spraying process S+ the water spraying process W. At this time, the steam washing modes A1, A2, A3, and A4 have different numbers of execution times of the steam washing pattern α1, α2, α3, and α4.

A single steam washing pattern is employed i.e. (S+W). However, one of ordinary skill in the art would recognize that the steam washing patterns as described above and illustrated in FIG. 6 is exemplary. Other single steam washing patterns are possible.

Hereinafter, a second embodiment of the steam washing mode of the dish washing machine according to the present invention will be described in detail with reference to FIG. 7.

In this embodiment, steam washing modes have different steam washing patterns and different numbers of execution times of the steam washing patterns. That is, different steam washing modes may have different steam washing patterns. Of course, steam washing modes may be selected depending upon the kinds of steam washing patterns, although the steam washing patterns have the same number of execution times.

Specifically, different steam washing modes A1, B1, C1, and D1 have different numbers of execution times α1, α2, α3, and α4. The steam washing modes A1, B1, C1, and D1 have different steam washing patterns, i.e., the steam spraying process S+ the water spraying process W, the steam spraying process S+ the water/steam spraying process SW, the water spraying process W+ the water/steam spraying process SW, and the steam spraying process S+ the water spraying process W+ the water/steam spraying process SW, respectively.

Multiple steam washing patterns are employed i.e. (S+W, S+SW, W+SW, and S+W+SW). However, one of ordinary skill in the art would recognize that the steam washing patterns as described above and illustrated in FIG. 7 are exemplary. Other steam washing patterns are possible.

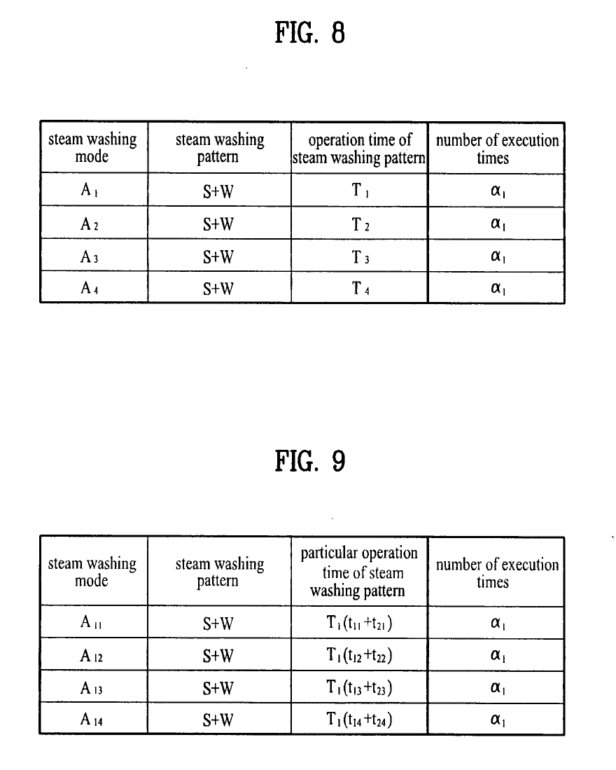

Hereinafter, a third embodiment of the steam washing mode of the dish washing machine according to the present invention will be described in detail with reference to FIG. 8.

In this embodiment, when the pattern operation times of steam washing patterns are different from each other, although the steam washing patterns and the numbers of execution times of the steam washing patterns are the same, the washing mode is changed.

Specifically, different steam washing modes A1, A2, A3, and A4 have the same steam washing pattern, i.e., the steam spraying process S+ the water spraying process W, and the same number of execution times α1. However, the steam washing modes A1, A2, A3, and A4 have the different pattern operation times of the steam washing patterns T1, T2, T3, and T4. Here, the pattern operation time of each steam washing pattern indicates the time necessary to perform the steam washing pattern once.

A single steam washing pattern is employed i.e. (S+W). However, one of ordinary skill in the art would recognize that the steam washing patterns as described above and illustrated in FIG. 8 is exemplary. Other single steam washing patterns are possible

Hereinafter, a fourth embodiment of the steam washing mode of the dish washing machine according to the present invention will be described in detail with reference to FIG. 9.

In this embodiment, when the operation times for the spraying processes included in steam washing patterns are different from each other, although the steam washing patterns, the numbers of execution times of the steam washing patterns, and the pattern operation times necessary to perform the steam washing patterns once are the same, the present invention has different steam washing modes.

Specifically, different steam washing modes A11, A12, A13, and A14 have the same steam washing pattern, i.e., the steam spraying process S+ the water spraying process W, and the same number of execution times α1, and the same pattern operation time T1. However, particular operation times constituting the pattern operation time T1 are different from each other.

That is, the pattern operation time T1 of the steam washing mode A11 includes a particular operation time t11 necessary to perform the steam spraying process S and a particular operation time t21 necessary to perform the water spraying process W.

Also, the pattern operation time T1 of the steam washing mode A12 includes a particular operation time t12 necessary to perform the steam spraying process S and a particular operation time t22 necessary to perform the water spraying process W.

Also, the pattern operation time T1 of the steam washing mode A13 includes a particular operation time t13 necessary to perform the steam spraying process S and a particular operation time t23 necessary to perform the water spraying process W.

Also, the pattern operation time T1 of the steam washing mode A14 includes a particular operation time t14 necessary to perform the steam spraying process S and a particular operation time t24 necessary to perform the water spraying process W.

A single steam washing pattern is employed i.e. (S+W). However, one of ordinary skill in the art would recognize that the steam washing patterns as described above and illustrated in FIG. 9 is exemplary. Other single steam washing patterns are possible

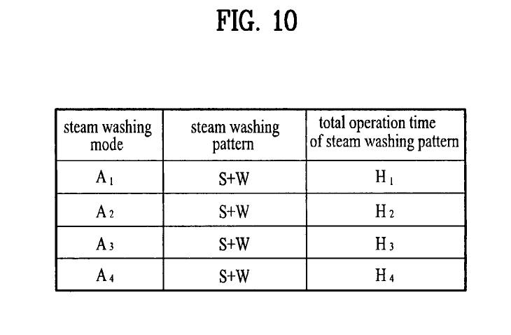

Hereinafter, a fifth embodiment of the steam washing mode of the dish washing machine according to the present invention will be described in detail with reference to FIG. 10.

In this embodiment, the steam washing mode is changed depending upon the total operation times necessary to repeatedly perform steam washing patterns, although the steam washing patterns are the same.

For example, different steam washing modes A1, A2, A3, and A4 have the same steam washing pattern, i.e., the steam spraying process S+ the water spraying process W. However, the steam washing modes A1, A2, A3, and A4 have different total operation times H1, H2, H3, and H4.

Of course, the total operation times may be expressed by the product of the number of execution times of the steam washing pattern and the pattern operation times of the steam washing pattern.

A single steam washing pattern is employed i.e. (S+W). However, one of ordinary skill in the art would recognize that the steam washing patterns as described above and illustrated in FIG. 10 is exemplary. Other single steam washing patterns are possible.

Hereinafter, the operation of the dish washing machine based on steam washing patterns will be described with reference to FIGS. 1 and 11A to 11D.

The steam washing patterns according to the present invention may be classified into four patterns.

Specifically, the steam washing patterns are classified into a first steam washing pattern including the water spraying process W and the steam spraying process S, a second steam washing pattern including the water/steam spraying process SW and the steam spraying process S, a third steam washing pattern including the water spraying process W and spraying process SW, and a fourth steam washing pattern including the water W, the steam spraying process S, and the water/steam spraying process SW.

FIG. 11A illustrates the first steam washing pattern of the steam washing mode. Water, heated by the first heater 290, is supplied for a predetermined period of time, and steam, generated by the second heater 310, is supplied for a predetermined period of time. These processes occur sequentially for the predetermined execution time.

The water spraying process W is carried out to remove foreign matter from the dishes, and the steam spraying process S is carried out to sufficiently soak the dishes such that the foreign matter can be easily removed from the dishes.

At this time, the washing temperature continuously rises. This is because the surface temperature of the dishes as well as the interior temperature of the washing compartment 150 continuously rises under the influence of the heated water and steam.

In a steam washing mode having the second steam washing pattern, as shown in FIG. 11B, the water/steam spraying process SW and the steam spraying process S are repeatedly carried out sequentially. Here, one cycle C1 for the second steam washing pattern means the cycle during which the water/steam spraying process SW and the steam spraying process S are carried out once.

Specifically, water, heated by the first heater 290, is repeatedly supplied at predetermined time intervals, and steam, generated by the second heater 310, is continuously supplied until the main washing operation is completed. As a result, the control unit 131 controls the second steam washing pattern to be repeatedly performed according to the predetermined number of execution times.

In the water/steam spraying process, the water and the steam are simultaneously supplied to the dishes through separate routes. Specifically, the water is heated in the sump 200, and is then supplied into the washing compartment 150 through the spray arms 220 and 230. Whereas, the steam is generated by the steam generator 300, and is then supplied into the washing compartment 150 through the steam supply tube 280.

The control unit 131 may decide the number of water supplies for supplying water necessary to generate the steam according to the selected number of execution times of the steam washing pattern. As shown in FIG. 11B, water is supplied to the steam generator whenever the second steam washing pattern is performed twice.

Specifically, water is first supplied to the steam generator at time point P1, and is then resupplied to the steam generator at time point P2 at which two cycles C1 and C2 for the second steam washing pattern have elapsed.

In a steam washing mode having the third steam washing pattern, as shown in FIG. 11C, the water/steam spraying process SW and the water spraying process W are repeatedly carried out sequentially. Here, one cycle C1 for the third steam washing pattern means the cycle during which the water/steam spraying process SW and the water spraying process W are carried out once.

Specifically, water, heated by the first heater 290, is continuously supplied until the main washing operation is completed, and steam, generated by the second heater 310, is supplied, for a predetermined number of execution times, at predetermined time intervals. As a result, the control unit 131 controls the third steam washing pattern to be repeatedly performed according to the predetermined number of execution times.

In a steam washing mode having the fourth steam washing pattern, as shown in FIG. 11D, the steam spraying process S, the water spraying process W, and the water/steam spraying process SW are repeatedly carried out sequentially. Here, one cycle C1 for the fourth steam washing pattern means the cycle during which the steam spraying process S, the water spraying process W, and the water/steam spraying process SW are carried out once.

Specifically, when it is assumed that the time in which the main washing operation is initiated is 0, only steam is supplied until time T1, only water is supplied between time T1 and time T2, and both water and steam are supplied between time T2 and time T3.

The control unit 131 may decide the number of water supplies for supplying water necessary to generate the steam according to the selected number of execution times of the steam washing pattern. As shown in FIG. 11D, water is supplied to the steam generator whenever the fourth steam washing pattern is performed twice.

Specifically, water is first supplied to the steam generator at time point P1, and is then resupplied to the steam generator at time point P2 at which two cycles C1 and C2 for the fourth steam washing pattern have elapsed.

The steam washing pattern includes a single steam washing pattern, and this single steam washing pattern is repeatedly performed, by which, however, the present invention is not limited. For example, the steam washing pattern may include plural steam washing patterns, which may be sequentially performed.

In addition, the steam washing pattern may be performed in at least one of the preliminary washing operation, the main washing operation, and the rinsing operation.

As apparent from the above description, the control method of the dish washing machine according to the present invention has the following effects.

First, it is possible to accomplish various dish washing methods through the use of the steam washing pattern including at least two of the water spraying process, the steam spraying process, and the water/steam spraying process. Consequently, the present invention has the effect of rapidly washing dishes even using a small amount of water.

Secondly, it is possible to decide the operation mode of the dish washing machine according to the contamination level of dishes or information inputted by a user. Consequently, the present invention has the effect of efficiently washing dishes.

It will be apparent to those skilled in the art that various modifications and variations can be made. Thus, it is intended that the claims cover these modifications and variations.

What is claimed is:

1. A method of controlling a dish washing machine comprising:
selecting one of a plurality of steam washing modes, wherein each of the steam washing modes has a corresponding steam washing pattern; and
selecting a number of steam washing pattern cycles for the selected steam washing mode.

2. The method of claim 1, wherein each of the corresponding steam washing patterns associated with each of the plurality of steam washing modes is different.

3. The method of claim 1, wherein the steam washing pattern associated with the selected steam washing mode includes at least two of:
a water spraying process for supplying water;
a steam spraying process for supplying steam; and
a water/steam spraying process for simultaneously supplying water and steam, wherein the at least two processes are sequentially carried out.

4. The method of claim 1, wherein the steam washing mode is selected by a user.

5. The method of claim 1, wherein the steam washing mode is selected on the basis of a load detected by a contamination sensor.

6. The method of claim 1, wherein the number of steam washing pattern cycles are selected by a user.

7. The method of claim 1, wherein the number of steam washing pattern cycles are selected on the basis of a load detected by a contamination sensor.

8. A method of controlling a dish washing machine comprising:
selecting one of a plurality of steam washing modes, wherein each of the steam washing modes has a corresponding steam washing pattern; and
selecting an operating time associated with the steam washing pattern that corresponds to the selected steam washing mode.

9. The method of claim 8 wherein each of the corresponding steam washing patterns associated with each of the plurality of steam washing modes is different.

10. The method of claim 8, wherein the steam washing pattern associated with the selected steam washing mode includes at least two of:
a water spraying process for supplying water;
a steam spraying process for supplying steam; and
a water/steam spraying process for simultaneously supplying water and steam, wherein at least two processes are sequentially carried out.

11. The method of claim 8, wherein the steam washing mode is selected by a user.

12. The method of claim 8, wherein the steam washing mode is selected on the basis of a load detected by a contamination sensor.

13. The method of claim 8 wherein the operation time associated with the steam washing pattern is selected by a user.

14. The method of claim 8, wherein the operation time associated with the steam washing pattern is selected on the basis of a load detected by a contamination sensor.

15. The method of claim 8, wherein the operation time associated with the steam washing pattern corresponds to one steam washing pattern cycle.

16. The method of claim 8, wherein the operation time associated with the steam washing pattern corresponds to a plurality of steam washing pattern cycles.

17. The method of claim 8, wherein the operation time is a function of the time associated with the steam washing pattern and the number of steam washing pattern cycles.

18. A dish washing machine comprising:
means for selecting one of a plurality of steam washing modes, wherein each of the steam washing modes has a corresponding steam washing pattern; and
at least one of means for selecting a number of steam washing pattern cycles for the selected steam washing mode and means for selecting an operating time associated with the steam washing pattern that corresponds to the selected steam washing mode.

19. The dish washing machine of claim 18 wherein each of the corresponding steam washing patterns associated with each of the plurality of steam washing modes is different.

20. The dish washing machine of claim 18, wherein the steam washing pattern associated with the selected steam washing mode includes at least two of:
a water spraying process for supplying water;
a steam spraying process for supplying steam; and
a water/steam spraying process for simultaneously supplying water and steam, wherein at least two processes are sequentially carried out.

21. The dish washing machine of claim 18, wherein the steam washing mode is selected by a user.

22. The dish washing machine of claim 18, wherein the steam washing mode is selected on the basis of a load detected by a contamination sensor.

23. The dish washing machine of claim 18 wherein the operation time associated with the steam washing pattern is selected by a user.

24. The dish washing machine of claim 18, wherein the operation time associated with the steam washing pattern is selected on the basis of a load detected by a contamination sensor.

25. The dish washing machine of claim 18, wherein the operation time associated with the steam washing pattern corresponds to one steam washing pattern cycle.

26. The dish washing machine of claim 18, wherein the operation time associated with the steam washing pattern corresponds to a plurality of steam washing pattern cycles.

27. The dish washing machine of claim 18, wherein the operation time is a function of the time associated with the steam washing pattern and the number of steam washing pattern cycles.
